(19) United States
(12) Patent Application Publication
(10) Pub. No.: US 2005/0093980 A1
(43) Pub. Date: May 5, 2005

(54) Portable electronic device and photography-restricting system

(75) Inventors: Yuichi Nonaka, Yokohama (JP); Toshiro Kinugasa, Hiratsuka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: HITACHI, LTD., Tokyo (JP)

(21) Appl. No.: 10/963,864

(22) Filed: Oct. 12, 2004

(30) Foreign Application Priority Data
Oct. 29, 2003 (JP) 2003-368302

(51) Int. Cl. H04N 5/225

(52) U.S. Cl. 348/207.99

(57) ABSTRACT

A portable electronic device comprises a photograph-taking component configured to capture an image of an object; a receiver configured to receive information on photography restriction from a first external communication source, wherein the first external communication source transmits first information if the portable electronic device is considered to be within a photography restriction area; and a controller configured to place the portable electronic device in a restricted photography mode if the first information is received by the receiver, the restricted photography mode allowing the photograph-taking component to capture an image of a given object, the captured given object being represented by image data. The portable electronic device is configured to operate the photograph-taking component in the restricted photography mode and a non-restricted photography mode.

### CROSS-REFERENCES TO RELATED APPLICATIONS

The present application claims priority to Japanese Patent Application No. 2003-368302, filed on Oct. 29, 2003.

### BACKGROUND OF THE INVENTION

The present invention relates to placing restriction on the photographic function of a portable electronic device.

JP Unexamined Patent Pub. No. 1999-261674 discloses a photography-restricting system to automatically prohibit the photographic function of a portable device in prohibited modes in facilities where such a use of portable electric devices in specific modes is restricted. The photography-restricting system comprises a controller installed on a ceiling or the like in public facilities and a portable electric device comprising a portable telephone. The portable electric device has a plurality of operating modes. The controller comprises a signal-generating circuit, a transmission circuit, an antenna, etc., and transmits control signals periodically in the public facilities. The portable electric device comprises an antenna, a receiving unit, a transmitting unit, a transmitter/receiver unit, etc. The transmitter/receiver unit has an operating-mode-setting means for shifting from a standby-for-receiving mode to a receiving-prohibiting mode.

JP Unexamined Patent Pub. No. 2002-135838 discloses an automatic control system to restrict the operation of portable electric devices in places where restriction is required and does not restrict the operation of portable electric devices in other places where restriction is not required. The automatic control system of portable electric devices is capable of automatic changeovers, rendering it unnecessary to ask people not to take photos or not to use flashlights. More specifically, a radio wave carrying a control signal is transmitted into a zone, which people pass through, for restricted place or space. On the other hand, a radio wave carrying a restriction-lifting signal is transmitted into a zone, which people pass through, for places where restriction is not required. The portable electric devices which have received the restriction-lifting signal return to the normal-operation mode.

JP Unexamined Patent Pub. No. 2002-27554 discloses a control technique for (i) improving the convenience of users and controlling the function of telephoning as well as other functions of a portable terminal 101 by controlling the functions of the terminal from the viewpoints of users in addition to the unilateral control of functions of the terminal from a station. A device 102 for transmitting and receiving radio waves in local areas generates and transmits function-regulating information, which corresponds to the regulations in a specific area, to restrict the operation of cameras 113 and recording means 114 of portable terminals 101 in the specific area. The local transmitting/receiving means 111 of portable terminals 101 receive the function-regulating information from the device 102. When the function-control means 118 of portable terminals 101 find that the function-regulating information is of the prohibition of a function or functions, the outputting means 117 of portable terminals 101 notify the users of the prohibition by means of display, sound, or vibration.

### BRIEF SUMMARY OF THE INVENTION

Portable electronic devices with camera functions have become very popular recently. With such portable electronic devices, people can take photographs easily at any place. It is sometimes, however, desirable to prevent people from taking pictures using such devices for various reasons, e.g., to protect a person's privacy.

The above JP patent applications are directed to address such a concern. The techniques disclosed thereto, however, restrict the photography function of all portable electronic devices in a given area; therefore, if an unforeseen event occurs for which photography is needed, these devices cannot be used to take pictures. Also, it is not possible to allow one group of portable electronic devices to take pictures while restricting another group of portable electronic devices from taking pictures, or restrict the use of portable electronic devices in different ways at different times.

Accordingly, one feature of the present invention provides an information processor capable of solving the above problems and improving the convenience of users.

In one embodiment, a portable electronic device comprises a photograph-taking component configured to capture an image of an object; a receiver configured to receive information on photography restriction from a first external communication source, wherein the first external communication source transmits first information if the portable electronic device is considered to be within a photography restriction area; and a controller configured to place the portable electronic device in a restricted photography mode if the first information is received by the receiver, the restricted photography mode allowing the photograph-taking component to capture an image of a given object, the captured given object being represented by image data. The portable electronic device is configured to operate the photograph-taking component in the restricted photography mode and a non-restricted photography mode.

In one embodiment, a method for controlling an image capturing feature of a portable electronic device configured to capture images includes receiving a photography restriction signal by the portable electronic device from a communication source provided external to the portable electronic device; converting a photography mode of the portable electronic device from a first photography-capturing mode to a second photography-capturing mode in response to the photography restriction signal received from the external communication source; and thereafter, capturing an image of an object using the second photography-capturing mode of the portable electronic.

In another embodiment, a portable electronic device including an image capturing feature includes means for receiving a photography restriction signal by the portable electronic device from a communication source provided external to the portable electronic device; means for setting the portable electronic device from a first photography-capturing mode to a second photography-capturing mode in response to the photography restriction signal received from the external communication source; and means for capturing an image of an object using the second photography-capturing mode of the portable electronic.

Yet another embodiment is directed to a handheld electronic device including a computer program for controlling an image capturing feature of the handheld electronic device. The program comprises code for receiving a photography restriction signal by the handheld electronic device from a communication source provided external to the handheld electronic device; code for converting a photography mode of the handheld electronic device from a first photography-capturing mode to a second photography-capturing mode in response to the photography restriction signal received from the external communication source; and code for capturing an image of an object using the second photography-capturing mode of the handheld electronic.

### BRIEF DESCRIPTION OF THE DRAWINGS

FIG. 1 is an illustration of a system for restricting the photograph-taking functions of portable electronic devices in accordance with embodiments of the present invention.

FIG. 2 is a block diagram of a portable electronic device of FIG. 1.

FIG. 3 is a block diagram of the portable electronic device in the system for restricting the photo-taking functions of portable electronic devices according to the first embodiment of the present invention.

FIG. 4 is an exemplary flowchart restricting the photograph-taking function performed by the portable electronic device of FIG. 3.

FIG. 5 is an example of the notice of restriction of photography to be displayed on the displaying unit of the portable electronic device of FIG. 3.

FIG. 6 is an exemplary flowchart for displaying a photograph taken according to the flowchart of FIG. 4 on the displaying unit of the portable electronic device.

FIG. 7 is a block diagram of the portable electronic device in the system for restricting the photograph-taking functions of portable electronic devices according to the second embodiment of the present invention.

FIG. 8 is an exemplary flowchart restricting the photograph-taking function of the portable electronic device of FIG. 7.

FIG. 9 is a block diagram of the portable electronic device in the system for restricting the photograph-taking functions of portable electronic devices according to the third embodiment of the present invention.

FIG. 10 is an exemplary flowchart restricting the photograph-taking function of the portable electronic device of FIG. 9.

FIG. 11 is a block diagram of the portable electronic device in the system for restricting the photograph-taking functions of portable electronic devices according to the fourth embodiment of the present invention.

FIG. 12 illustrates a process for restricting the photograph-taking function of the portable electronic device of FIG. 1, according to one embodiment of the present invention.

FIG. 13 is a block diagram of the portable electronic device in the system for restricting the photograph-taking functions of portable electronic devices according to the fifth embodiment of the present invention.

FIG. 14 illustrates a process for restricting the photograph-taking function of the portable electronic device of FIG. 13, according to one embodiment of the present invention.

FIG. 15 illustrates a process for lifting the restriction of photography in accordance with the sixth embodiment of the present invention.

### DETAILED DESCRIPTION OF THE INVENTION

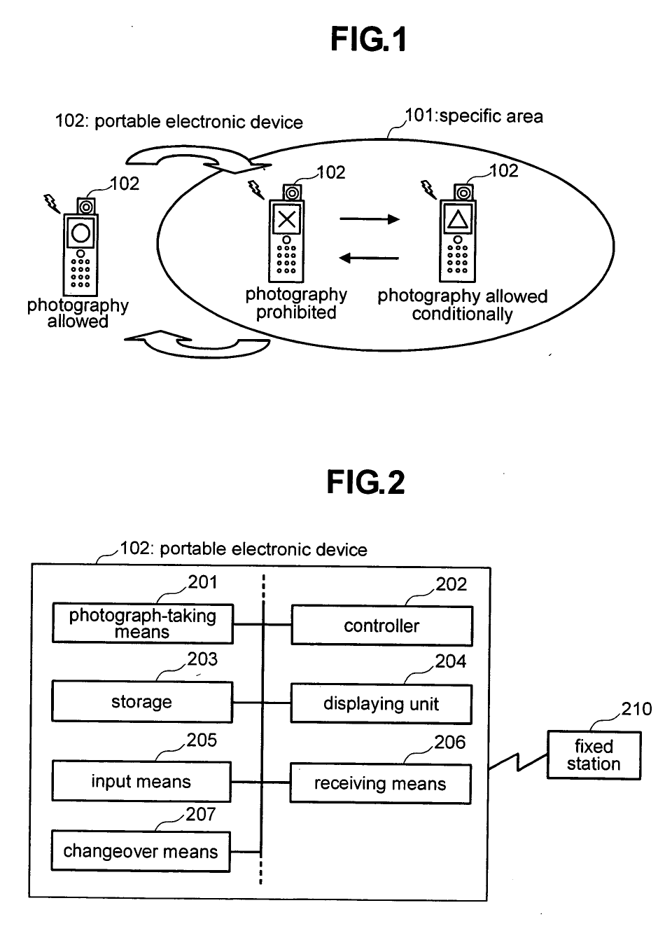

With reference to drawings, preferred embodiments for a system to restrict the functions of photography of cameras that are integrated to portable electronic devices in accordance with the present invention are described below in detail. FIG. 1 is an exemplary illustration of the system.

A specific area 101 is a designated area, such as the inside of a movie theater or concert hall. The camera features of portable electronic devices 102 are restricted when they are brought into the specific area 101. This restriction is lifted by performing a predefined procedure or adding another restriction.

FIG. 2 is an exemplary block diagram of a portable electronic device 102. The portable electronic device 102 comprises a photograph-taking means 201 (or camera or camera component), a controller 202 to control the portable electronic device 102, a storage 203 to store image data, a displaying unit 204 such as a display or speaker, an input means 205 such as buttons for a user to input data and instructions, a receiving means 206 to receive signals including information about the restriction of photography from a fixed station 210, and a means 207 for switching to different operations. The operation-changeover means 207 may be included in the controller 202.

With the above construction, the changeover means 207 restricts the function of photography of the portable electronic device 102 and lifts the restriction in accordance with the information about the restriction of photography received by the receiving means 206. Information about the restriction of photography is included in prescribed control signals to be transmitted from a transmitter installed in the specific area 101 or at a gateway of the specific area 101.

With reference to drawings, the restriction of photography by the operation-changeover means 207 will be described below.

First Embodiment

The restriction of the function of displaying a photographed image by encoding its image data before storage are described below.

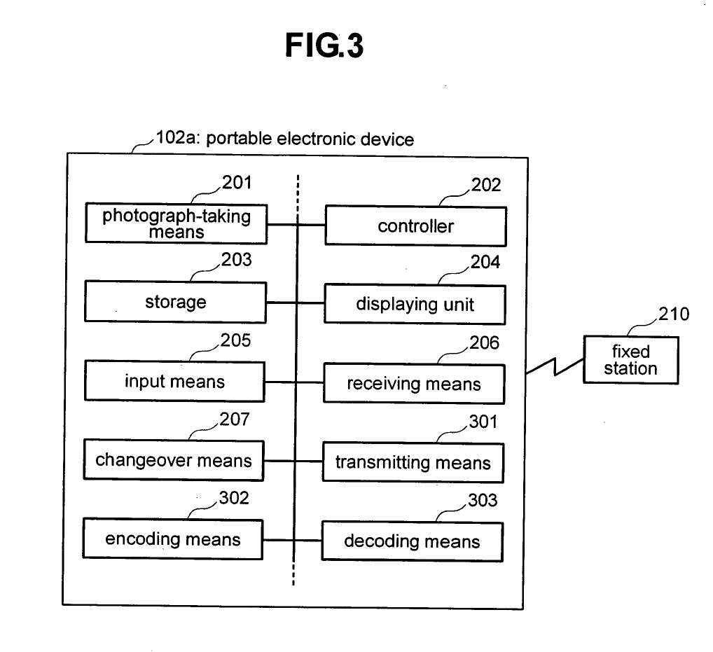

FIG. 3 is a block diagram of the portable electronic device 102 according to the first embodiment. The portable electronic device 102a of FIG. 3 corresponds to the portable electronic device 102 of FIG. 2 plus a transmitting means 301, an encoding means 302, and a decoding means 303. The portable electronic device may be a handheld device that is configured to be operated while being held on a user's hand. Examples of such handheld devices include mobile phones and personal digital assistants.

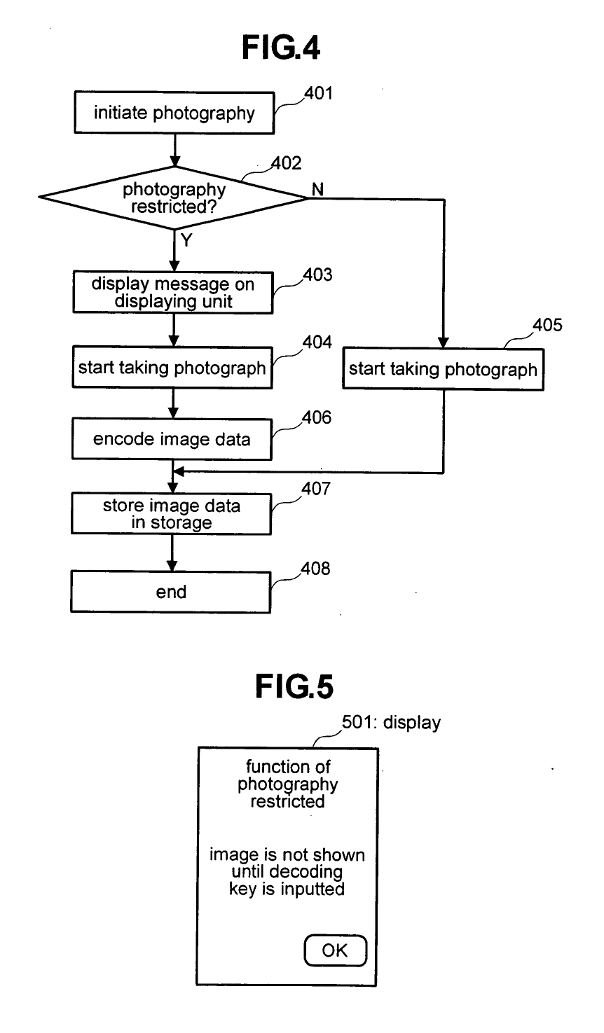

FIG. 4 is a flowchart of the process 400 of the control of functions performed by the portable electronic device 102a. In Step 401, the user of the portable electronic device 102a operates the input means 205 to take pictures using the photograph-taking means 201. In Step 402, it is determined whether or not photography is restricted based on information received by the receiving means 206. If photography is not restricted, a picture is taken in Step 405 and its image data are stored in the storage 203 in Step 407. Then, the process ends in Step 408. If it is determined in Step 402 that photography is restricted, the message shown in FIG. 5 is displayed on the displaying unit 204 to notify the restriction to the user of the portable electronic device 102a. Then, a photograph is taken in Step 404 and its image data are encoded by the encoding means 302 in Step 406. The encoded image data are stored in the storage 203 in Step 407 and the process ends in Step 408.

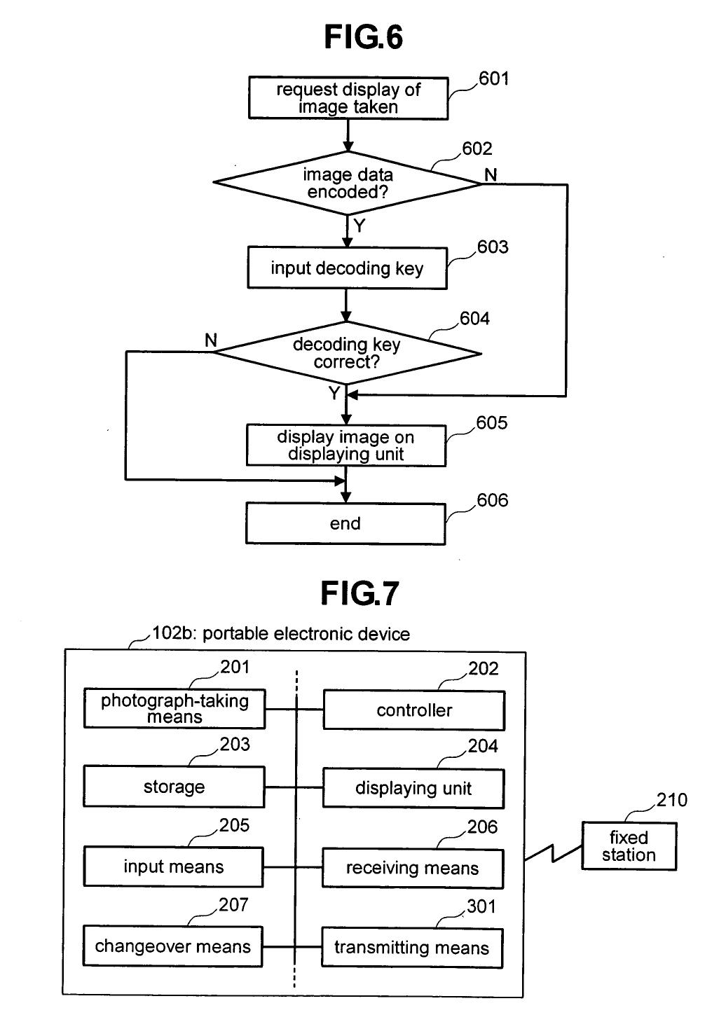

FIG. 6 illustrates a process 660 for displaying the picture taken according to the process 400 on the displaying unit 204, according to one embodiment.

In Step 601, the user of the portable electronic device 102 operates the input means 205 to request the display of the picture taken according to the process 400 on the displaying unit 204. In Step 602, the controller 202 determines whether or not the image data of the picture are encoded. If the image data are not encoded, the picture is displayed in Step 605. Then, the process ends in Step 606. If the controller 202 determines in Step 602 that the image data are encoded, a decoding key is inputted in Step 603. In Step 604, it is determined whether or not the decoding key is correct. If the decoding key is correct, the encoded image data are decoded by the decoding means 303 and the image or picture is displayed (Step 605). Then, the process ends in Step 606. If the decoding key is wrong or no decoding key is inputted, the process ends without displaying the image/picture in Step 606.

A decoding key may be obtained by sending the image data of a taken photograph to a certain database of a police station, firehouse, or the like through the transmitting means 301 or by making a payment to a charging system.

Second Embodiment

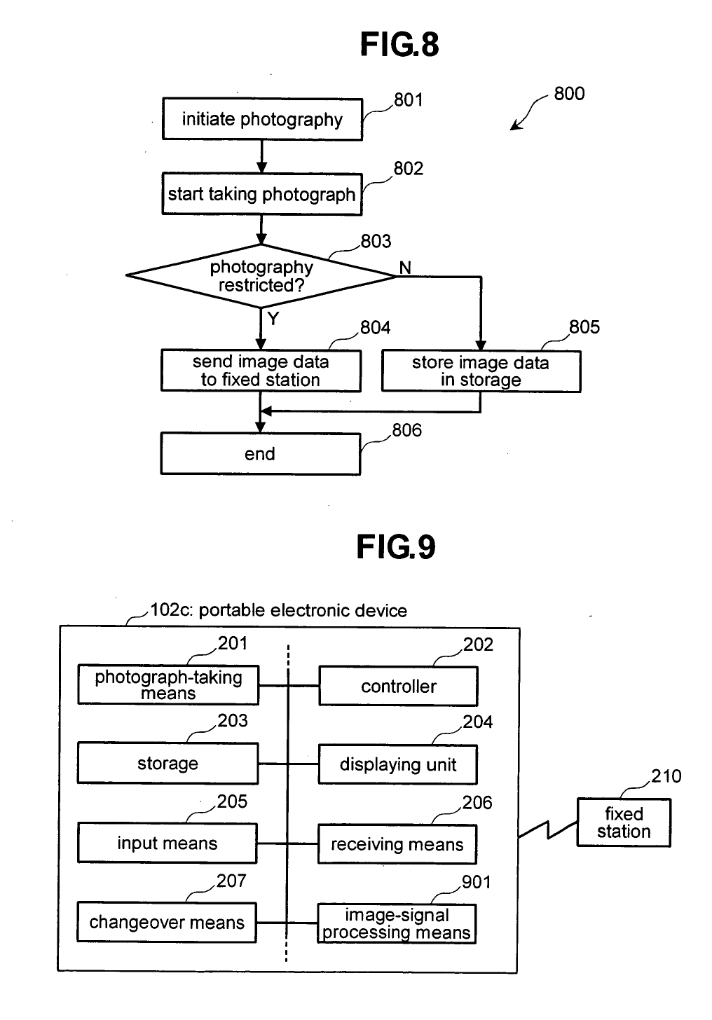

According to the second embodiment, the image data of the portable electronic device 102 are sent to a fixed station. FIG. 7 is a block diagram of the portable electronic device 102b according to the second embodiment, which corresponds to the portable electronic device 102 of FIG. 2 plus a transmitting means 301. FIG. 8 illustrates a process 800 performed by the portable electronic device 102b. In Step 801, the user of the portable electronic device 102b operates the input means 205 to take pictures using the photo-taking means 201. A picture is taken in Step 802. In Step 803, it is determined whether or not camera features are restricted based on the information received by the receiving means 206. If photography or camera feature is not restricted, the image data of the picture taken at step 802 are stored in the storage 203 in Step 805, and the process ends in Step 806. If photography is restricted, the image data of the photograph are sent to the fixed station 210 in Step 804 and the process ends in Step 806. The station 210 may be a server or storage system that is wirelessly coupled to the portable electronic device via the transmitting means 301.

When the user of the portable electronic device 102b requests the display of the photograph, the image data of the photograph are received from the fixed station 210 and the photograph is displayed on the displaying unit 204. The image data may be received either via a wireless or wired communication link. The restriction of photography is accomplished by storing image data not locally (in the portable electronic device 102b), but in a remotely located device (in the fixed station 210).

Third Embodiment

According to the third embodiment of the present invention, the photograph-taking modes of the portable electronic device 102 are restricted if it has two or more photograph-taking modes regarding the quality and resolution of images, the function of revising images by signal processing, etc.

FIG. 9 is a block diagram of the portable electronic device 102 of the third embodiment, which corresponds to the portable electronic device 102 of FIG. 2 plus an image-signal processing means 901.

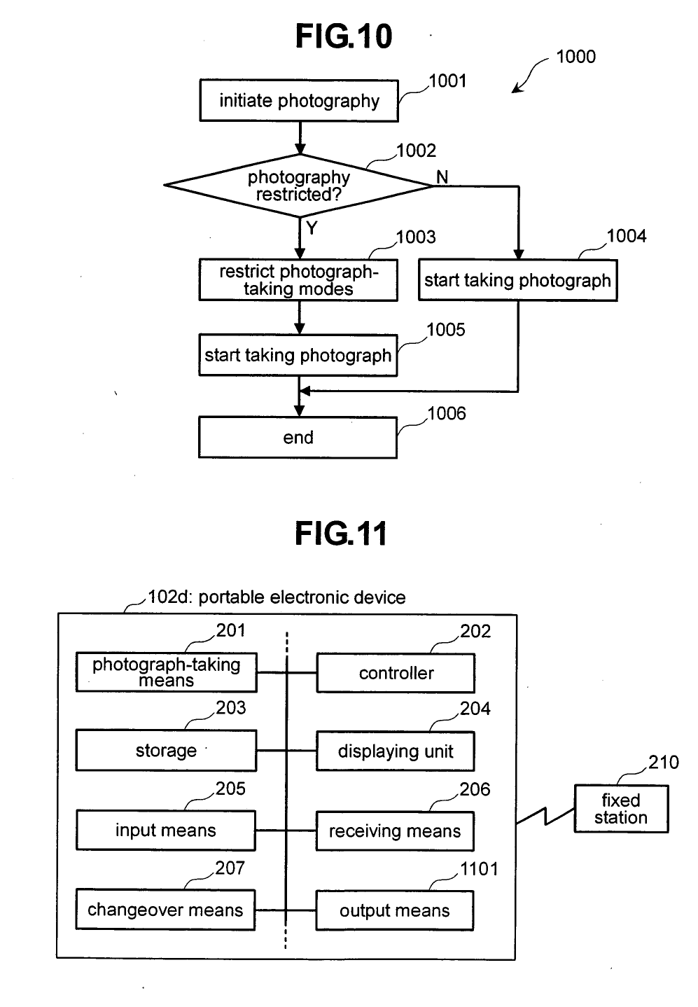

FIG. 10 illustrates a process 1000 relating to the control of functions of the portable electronic device 102c. In Step 1001, the user of the portable electronic device 102c operates the input means 205 to take a picture using the photo-taking means 201. In Step 1002, it is determined from the information received by the receiving means 206 whether or not photography is restricted. If photography is not restricted, a picture is taken in Step 1004, and the process ends in Step 1006. If photography is restricted, at least one or more functions of the image-signal processing means 901 are suspended in Step 1003 and a photograph is taken in Step 1005. Then, the process ends in Step 1006.

Fourth Embodiment

According to the fourth embodiment, the user of the portable electronic device 102 is notified of the restriction of photography by a siren or light emission.

FIG. 11 is a block diagram of the portable electronic device 102 according to the fourth embodiment, which corresponds to the portable electronic device 102 of FIG. 2 plus a means of outputting sound or light 1101.

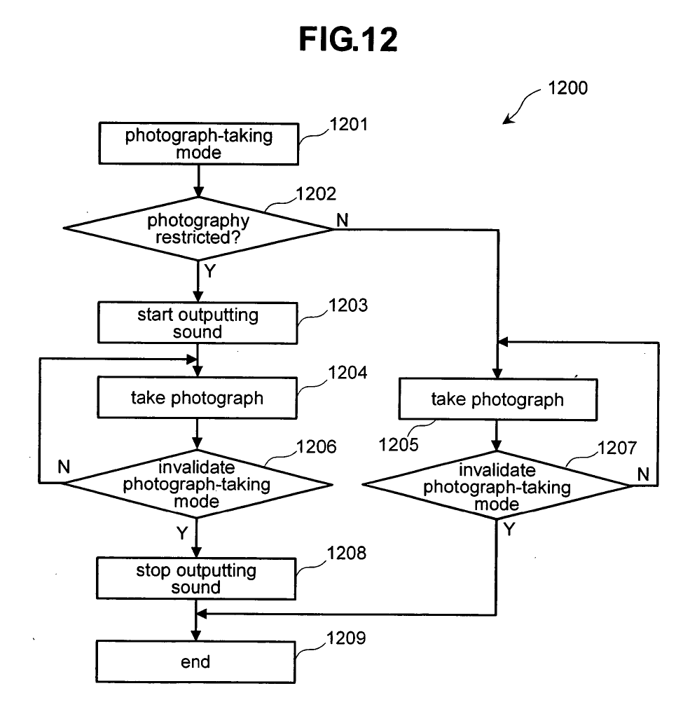

FIG. 12 illustrates a process 1200 relating to the control of functions of the portable electronic device 102d. In Step 1201, the portable electronic device 102d is placed in a photograph-taking mode. In Step 1202, it is determined from the information received by the receiving means 206 whether or not photography is restricted. If photography is not restricted, a photograph is taken in Step 1205, and the portable electronic device 102 is switched to non-photograph-taking mode in Step 1207. Then, the processing is ended in Step 1209. If photography is restricted, the means of outputting sound or light 1101 (or an outputting device) starts to output sound or light in Step 1203. A photograph is taken in Step 1204. The portable electronic device 102 is switched to a photograph-taking mode in Step 1206. The means of outputting sound or light 1101 stops outputting sound or light in Step 1208. Then, the process ends in Step 1209. According to this embodiment, sound or light is always outputted while the portable electronic device 102 is a photograph-taking mode. Thus, the intention of the user of the portable electronic device 102 to take photographs can be notified to people around him.

Fifth Embodiment

According to the fifth embodiment, the photograph-taking function of the photograph-taking means 201 is restricted and the restriction is lifted based on positional information obtained through a GPS function while the portable electronic device 102 is in the specific area 101.

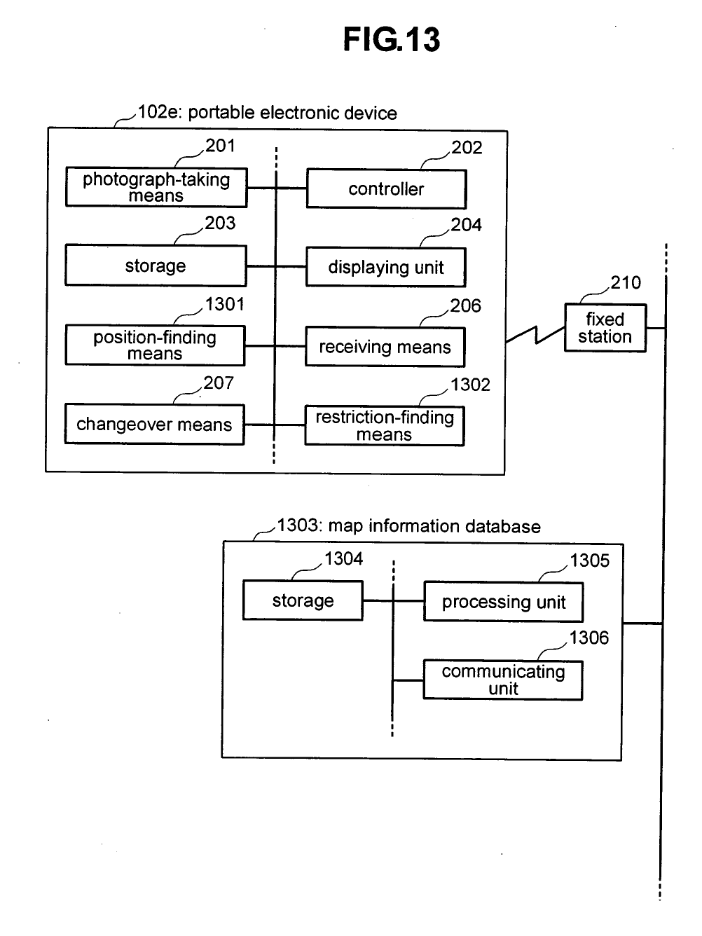

FIG. 13 is a block diagram of a system to restrict the photography of portable electronic devices 102e according to the fifth embodiment. The portable electronic device 102 comprises a photograph-taking means 201, a controller 202 to control the portable electronic device 102, a storage 203 to store image data, a displaying unit 204 such as a display, a means 206 of receiving signals from a fixed station 210, a means 207 of changeover among operations, a means 1301 of finding the position of the portable electronic device 102 based on the positional information, and a means 1302 of finding whether the position is within a restricted area or not. The reference numeral 1303 is a map information database, which comprises a storage 1304 to store information about restricted areas and restrictions in the restricted areas, a processing unit 1305, and a communicating unit 1306.

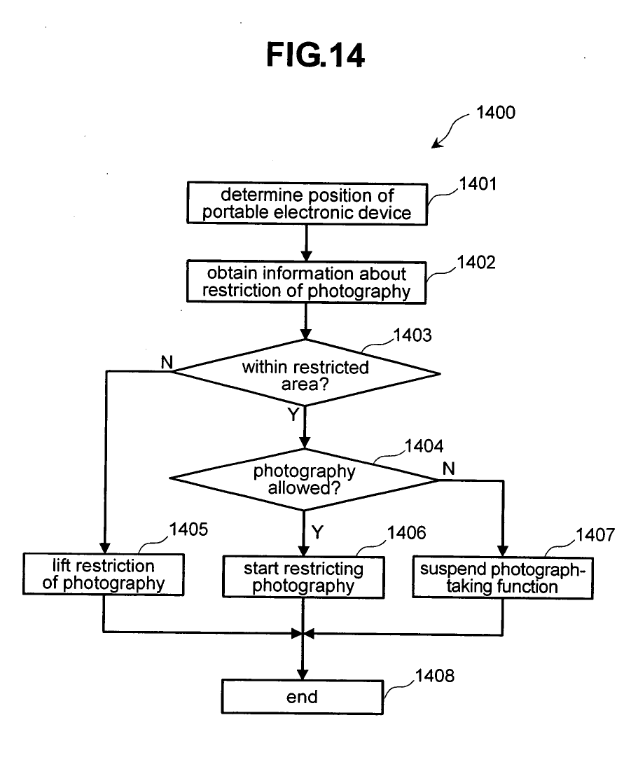

FIG. 14 illustrates a process 1400 for restricting photography feature of the above system. In Step 1401, the position-finding means 1301 determines the position of the portable electronic device 102. In Step 1402, the portable electronic device 102 gets the information about the restriction of photography stored in the storage 1304 of the map information database 1002 through the fixed station 210. In Step 1403, the means 1302 determines from the information on the restriction of photography whether or not the position of the portable electronic device 102 is within a restricted area. If the portable electronic device 102 is not within a restricted area and the photography feature of the portable electronic device 102 is restricted, the restriction on photography is lifted in Step 1405. Then, the process ends in Step 1408. If the portable electronic device 102 is within a restricted area, it is determined based on the information about the restriction on photography in Step 1404 whether or not photography is allowed. If photography is not allowed, the photograph-taking function of the portable electronic device 102 is suspended in Step 1407, and the process ends in Step 1408. If photography is allowed conditionally, the image data is encoded as described in the first embodiment, or the image data is transmitted to the fixed station 210, as described in the second embodiment, or part of signal processing is suspended as described in the third embodiment, or sound or light is outputted as described in the fourth embodiment in Step 1406. Then, the process ends in Step 1408.

Sixth Embodiment

According to the sixth embodiment, the restriction is lifted with or without other conditions if the portable electronic device 102 is within the specific area 101 and photography is restricted.

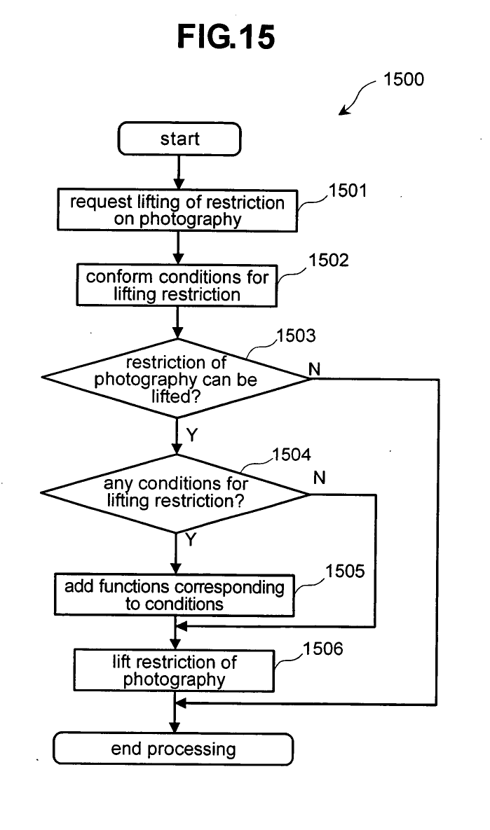

FIG. 15 illustrates a process 1500 for lifting the restriction of photography. In Step 1501, the user of the portable electronic device 102 operates the input means 205 to request lifting of the restriction of photography. In Step 1502, information on the restriction of photography is obtained through the receiving means 206. The information may also be obtained beforehand. In Step 1503, the controller 202 determines from the information in the restriction of photography whether or not the restriction of photography can be lifted. If the restriction cannot be lifted, the process ends. If the restriction can be lifted, the controller 202 determines in Step 1504 whether or not there are conditions for lifting the restriction. If there are no conditions for lifting the restriction, the restriction is lifted in Step 1506, and the process ends. If there are conditions for lifting the restriction, the functions corresponding to the conditions for lifting the restriction are added in Step 1505, and the restriction is lifted in Step 1506. Then, the process ends.

The user may choose one from a plurality of restrictions included in the information on the restriction of photography.

With the above configuration of the system, photographs can be taken even in restricted areas if conditions for photography are satisfied.

As described above, according to the present invention, portable electronic devices, e.g., cell phones, may be used to take pictures in restricted areas under certain situations while preventing unauthorized photography in a restricted place by suspending one or more functions of the above photograph-taking means. Besides, by adding a system to lift the suspension of functions, either unconditionally or conditionally, under certain specific circumstances, portable electronic devices are allowed in emergency or such suspension of functions can be imposed on only certain selected portable electronic devices or persons. Moreover, a system for billing users of portable electronic devices for photography in specific areas can be constructed by combining the above system for restricting photography and a charging payment system.

According to the present embodiments, the photograph-taking functions of portable electronic devices with the function of a video camera can be appropriately restricted in public facilities such as movie theaters, art museums, and concert halls.

The present invention has been described using specific embodiments. These embodiments may be modified or changed without departing from the scope of the present invention. The scope of the present invention, accordingly, should be determined using the appended claims.

1. A portable electronic device comprising:
a photograph-taking component configured to capture an image of an object;
a receiver configured to receive information on photography restriction from a first external communication source, wherein the first external communication source transmits first information if the portable electronic device is considered to be within a photography restriction area; and
a controller configured to place the portable electronic device in a restricted photography mode if the first information is received by the receiver, the restricted photography mode allowing the photograph-taking component to capture an image of a given object, the captured given object being represented by image data,
wherein the portable electronic device is configured to operate the photograph-taking component in the restricted photography mode and a non-restricted photography mode.

2. The device of claim 1, further comprising:
an encoder configured to encode the image data of the captured given object if the first information is received by the receiver.

3. The device of claim 2, further comprising:
a decoder configured to decode the encoded image data based on permission received from a second external source.

4. The device of claim 2, wherein the captured image is not displayed on a display of the portable electronic device.

5. The device of claim 4, wherein the image of the captured given object is displayed on the display of the portable electronic device if an authorization is received from a second external source.

6. The device of claim 1, further comprising:
a transmitter to transmit the image data of the captured given object to a remote device if the first information is received and the portable electronic device is placed in the restricted photography mode.

7. The device of claim 6, wherein the image of the captured given object is not displayed on a display of the portable electronic device if the portable electronic device is placed in the restricted photography mode.

8. The device of claim 1, wherein the image data of the captured given object is of a first type if the given object is captured in the restricted photography mode and a second type if the given object is captured in the non-restricted photography mode.

9. The device of claim 8, wherein the image data of the first type is a low quality picture and the image data of the second type is a high quality picture.

10. The device of claim 1, further comprising:
an output component configured to output a sound or light when an image is captured in the restricted photography mode and output no sound or light when an image is captured in the non-restricted photography mode.

11. The device of claim 10, wherein the controller controls the output component according to the restricted photography mode or non-restricted photography mode of the portable electronic device.

12. The device of claim 1, wherein the portable electronic device is configured to receive and transmit audio signals to provide telephone features.

13. The device of claim 1, where in the portable electronic device is configured to be held and operated in a hand of a user.

14. A method for controlling an image capturing feature of a portable electronic device configured to capture images, the method comprising:
receiving a photography restriction signal by the portable electronic device from a communication source provided external to the portable electronic device;
converting a photography mode of the portable electronic device from a first photography-capturing mode to a second photography-capturing mode in response to the photography restriction signal received from the external communication source; and
thereafter, capturing an image of an object using the second photography-capturing mode of the portable electronic.

15. The method of claim 14, wherein the external communication source is configured to send the photography restriction signal to portable electronic devices that are within an area wherein photography is restricted.

16. The method of claim 14, wherein the first photography-capturing mode is a normal mode wherein no photography restriction is placed on the portable electronic device, and the second photography-capturing mode is a restricted mode wherein one or more restrictions are placed on photographic features of the portable electronic device.

17. The method of claim 16, wherein the portable electronic device stores image data of a captured image in an encrypted form if the image is captured while the portable device is in the second photography-capturing mode.

18. The method of claim 16, wherein the portable electronic sends image data of a captured image to a remote location if the image is captured while the portable device is in the second photography-capturing mode.

19. A portable electronic device including an image capturing feature, the portable electronic device comprising
means for receiving a photography restriction signal by the portable electronic device from a communication source provided external to the portable electronic device;
means for setting the portable electronic device from a first photography-capturing mode to a second photography-capturing mode in response to the photography restriction signal received from the external communication source; and
means for capturing an image of an object using the second photography-capturing mode of the portable electronic.

20. A handheld electronic device including a computer program for controlling an image capturing feature of the handheld electronic device, the program comprising:
code for receiving a photography restriction signal by the handheld electronic device from a communication source provided external to the handheld electronic device;
code for converting a photography mode of the handheld electronic device from a first photography-capturing mode to a second photography-capturing mode in response to the photography restriction signal received from the external communication source; and
code for capturing an image of an object using the second photography-capturing mode of the handheld electronic.
